(19) United States
(12) Patent Application Publication
(10) Pub. No.: US 2008/0085952 A1
(43) Pub. Date: Apr. 10, 2008

(54) Superplasticisers Having Silane Functions

(76) Inventors: Ariane Touati, Pont De Cheruy (FR); Serge Ghilardi, Mery (FR); David Rinaldi, Saint Jean De Gonville (FR); Sebastien Georges, Mions (FR)

Correspondence Address: STITES & HARBISON PLLC, 1199 NORTH FAIRFAX STREET, SUITE 900, ALEXANDRIA, VA, 22314, US

(21) Appl. No.: 11/576,760

(22) PCT Filed: Oct. 4, 2005
(86) PCT No.: PCT/FR05/02438

§ 371 Date: Apr. 5, 2007

(30) Foreign Application Priority Data
Oct. 5, 2004 (FR) 0410499

(51) Int. Cl. C04B 24/40

(52) U.S. Cl. 524/3

(57) ABSTRACT

The invention concerns the use of a polymer comprising a hydrocarbon chain, silyl side groups and polyalkylated groups as additive for hydraulic binders. The invention also concerns an additive for hydraulic binders comprising said polymer, and a method for fluidizing and maintaining workability of mineral particle suspensions, and in particular of hydraulic binder compositions.

The present invention relates to the field of additives for hydraulic binders and in particular plasticisers and superplasticisers.

Generally, additives are added to hydraulic binders, such as cement compositions, allowing their characteristics to be improved. Fundamental characteristics of the hydraulic binders include the rheological characteristics and their development over time, associated with workability.

In particular, plasticisers are used which have the effect of fluidising hydraulic binders and which allow a reduction in the quantity of water added. That is the reason why they are also referred to as water reducers. The hydraulic binder has a higher density and results in a material which has higher mechanical strength.

Some soluble polymers, known as superplasticisers, allow a further reduction in the quantity of water. There are known in particular superplasticisers of the type involving polyalkoxylated polycarboxylic acids (PCP). However, they also have disadvantages.

On the one hand, their effectiveness is very sensitive to the chemical constitution of the cement.

Thus, differences in measures of superplasticiser are often observed depending on the nature of the cements. In particular, it appears that the mineralogical characteristics of the cements, and in particular their reactivity with respect to sulphate ions, influence the necessary measure of superplasticiser. It is supposed that the superplasticisers are in competition with the sulphate ions around the adsorption sites.

That makes it necessary to carry out compatibility tests in order to fix the measure of a superplasticiser for each cement that is capable of being used.

On the other hand, retaining the workability of the hydraulic binders added with superplasticisers is still unsatisfactory for some applications, such as ready-to-use concretes or self-placing concretes.

The object of the invention is to provide new compounds which are advantageous in particular as additives and which allow those disadvantages to be reduced.

It has been found that polymers comprising lateral silylated groups and polyoxyalkylene are advantageous as additives for cements because they have good robustness with respect to cements of different chemical types and allow the workability of the cement compositions to be extended.

In the context of the present disclosure, the term “hydraulic binder” is intended to refer to any hydraulically setting material, that is to say, in particular in addition to cements, such as Portland cements, mortars further comprising fine granulates, or concretes, further comprising coarse granulates. The term also includes anhydrous or semi-hydrated calcium sulphates.

The term “hydrocarbon chain” is intended to refer to a group comprising atoms of carbon and hydrogen, which is aliphatic, saturated or unsaturated, aromatic, arylalkyl or alkylaryl, branched or linear and which may be interrupted and/or terminated with one or more heteroatoms, such as S, O, N, P.

The term “alkyl group” is intended to refer to a linear alkyl group which is branched or cyclic.

According to a first aspect, the invention proposes the use of a polymer comprising a main hydrocarbon chain and lateral silylated groups and lateral polyoxyalkylated groups as an additive for hydraulic binders.

The proportion of the respective groups in the polymer may vary widely. Thus, the polymer preferably comprises from 0.001 to 50%, in particular from 1 to 30% and quite particularly from 5 to 20% of silyl groups in number.

The polymer comprises a proportion of polyoxyalkylated groups of from 1 to 80% in number, in particular from 10 to 50.

The polyoxyalkylated groups may be linked to the main chain or by way of different groups. Preferably, they are linked to the main chain by an ester, ether or amide bond.

The polymer may further comprise carboxylic groups, from 0 to 80%, in particular from 10 to 60% and quite particularly from 15 to 30% in number of carboxylic groups. Those groups may be in the form of a free acid or partially or completely neutralised.

The polymer generally has a mean molar mass of between 10,000 and 220,000 (Mw), preferably between 10,000 and 110,000 (Mw), as established by PGC in accordance with the protocol indicated in the experimental part.

The polymerisation index Ip is preferably between 1 and 5, preferably between 1.5 and 3.

Several types of reaction may be suitable for preparing the polymer described. In particular, it may be prepared by co-polymerisation of a plurality of co-monomers or by introducing to a polymer one or more types of lateral group. The latter method is also referred to as post-grafting.

Thus, according to one embodiment, the polymer described is prepared by co-polymerisation, in the presence of a suitable catalyst, of monomers which are capable of polymerisation and which carry the desired groups, respectively.

It is therefore possible to co-polymerise an admixture comprising a monomer carrying a silyl group with a monomer carrying a polyoxyalkyl group and optionally a monomer carrying a carboxylic group. The monomer may carry the polyoxyalkylated group by an ether, ester or amide bond.

In particular, the polymer may be prepared by co-polymerisation in the presence of a suitable catalyst of the following monomers:
(a) an insaturated derivative, or its ester, amide or corresponding salt, comprising a silyl group which is capable of releasing a silanol group during hydrolysis;
(b) An ethylenically insaturated polyoxyalkylated compound, optionally etherified; and, optionally,
(c) a ethylenically insaturated carboxylic acid or an ester, amide or salt thereof.

Monomer (a) is advantageously an ethylenically insaturated carboxylic acid, or an ester, amide or salt thereof.

Quite particularly, it may be an ester of an unsaturated acid and an alcohol carrying a silyl group. The unsaturated acid may in particular be selected from acrylic acid, methacrylic acid or the dicarboxylic acids set out below.

The alcohols carrying a silyl group may be derived in particular from the alkyl alcohols, such as methanol, ethanol, isopropanol, propanol, butanol, isobutanol, tert. butanol.

The silyl groups are groups comprising at least one silicon atom and at least one group which can be hydrolysed to yield a silanol group, for example, an Si—OR group, R preferably being an alkyl group of C₁, to C₆.

Those groups may include in particular the groups having a formula —Si(R)ₓ(OR)_{y}, where R are alkyl groups, preferably of C₁ to C₆, x is an integer from 0 to 2 and y is an integer from 1 to 3, the sum of x and y being 3 in order to satisfy the valency of silicon.

It is also possible to envisage that the central silicon atom carries itself one or more silyl groups, as defined above, provided that it has at least one group which is hydrolysable to form a silanol group.

The monomer (a) preferably complies with formula (I) below:

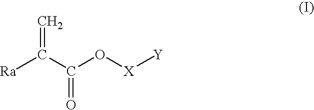

where:
Rₐ represents H or an alkyl group of C₁ to C₆, in particular methyl;
X is a spacer group, in particular an alkylene group of C₁ to C₆ or a chain of groups having the formula —(QO)ₙ—
   where:
Q represents an alkylene group having from 2 to 4 atoms of carbon or an admixture of those alkylene groups;
n is an integer of from 3 to 500;
Y represents a silyl group having the formula Si(ORₑ)ᵢ(Rf)ⱼ, Rₑ and R_{f} being, independently of each other, an alkyl group of C₁ to C₆, preferably methyl or ethyl, or a group having the formula Si(OR_{g})ᵢ(Rh)ⱼ; R_{g} and Rₕ being, independently of each other, an alkyl group of C₁ to C₆, and i being an integer from 1 to 3 and j being an integer equal to 3-i.

The spacer X is preferably an ethylene or propylene group.

According to one embodiment, monomer (b) preferably complies with formula (II) below:

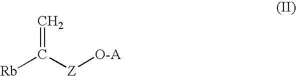

where: R_{b} represents H or an alkyl group of C₁ to C₆, preferably methyl;
Z is an alkylene group of C₁ to C₁₂, or a C═O group, or is absent; and
A is a group having the formula —(QO)ₙ—OP where:
Q represents an alkylene group having from 2 to 4 carbon atoms or an admixture of those alkylene groups;
n is an integer of from 3 to 500; and
P represents a hydrogen atom or an alkyl, aryl, alkylaryl or arylalkyl group of C₁ to C₁₂, preferably having from 1 to 4 carbon atoms and quite particularly methyl.

Monomer (b) can be selected in particular from the group constituted by monoesters, preferably methacrylates or acrylates, polyethylene glycol or polypropylene glycol or the co-polymers thereof, and the derivatives thereof in which the terminal group is etherified.

The molecular weight of the polyalkylene glycols is preferably from 100 to 10,000, in particular from 500 to 7,000.

In the event that Z is absent, an anhydride of carboxylic acid is preferably selected as the monomer (c).

Monomer (c), which may be present, preferably complies with formula (III) below:

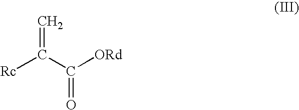

where:
R_{c} represents H or an alkyl group of C₁ to C₆, preferably methyl; and
R_{d} represents H or an alkyl, aryl, alkylaryl or arylalkyl group of C₁ to C₁₂, preferably methyl or ethyl.

By way of example, monomer (c) can be selected from the group constituted by methacrylic acid, acrylic acid, methyl (meth)acrylate, ethyl (meth)acrylate, propyl (meth)acrylate, isopropyl (meth)acrylate, butyl (meth)acrylate, isobutyl (meth)acrylate, tert. butyl (meth)acrylate, n-pentyl (meth)acrylate, n-hexyl (meth)acrylate.

Monomer (c) can also carry more than one carboxylic function. In particular, it may be selected from the group of dicarboxylic acids, such as crotonic acid, maleic acid, fumaric acid, itaconic acid, citraconic acid and the derivatives thereof, in particular the corresponding anhydrides, esters, salts and amides.

In addition to monomers, the admixture to be polymerised may further comprise other additives which are conventionally used, such as a transfer agent and/or an initialising substance.

It is possible to use, as the transfer agent, any compound agent that is conventionally envisaged for the purpose. This may include in particular thioglycolic acid or mercapto acetic acid.

The initialising substance may be selected from commercially available compounds for radical polymerisations. In this context, it is possible to mention, for example, azoic compounds.

The polymerisation reaction is advantageously a radical polymerisation. That type of reaction is known per se. The polymerisation reaction may be carried out in a suitable solvent, preferably a non-polar solvent.

The duration of the reaction depends on the reactivity of the monomers and the temperature. It is generally between 30 minutes and 10 hours.

The temperature of the reaction is selected in particular in accordance with the initialisation temperature of the catalyst. It is advantageously between 20 and 80° C.

After the reaction has finished, the solvent is separated. It may also be advantageous to neutralise completely or partially the carboxylic groups. The product is then ready for formulation.

According to another embodiment, the polymer is prepared by a method known as “post-grafting”. That method comprises grafting lateral silylated and/or polyoxyalkylated groups to a polymer comprising a hydrocarbon chain and reagent groups, for example, carboxylic groups. The grafting is preferably carried out by reacting the polymer with an alcohol or amine which is silylated and polyoxyalkylated, respectively.

The reagents used for grafting are in particular selected from the corresponding alcohols or amines, amines being preferred owing to their better reactivity at low temperature.

Thus, the post-grafting method may comprise the steps involving:
polymerising the monomer (c) in the presence of a polyoxyalkylated compound; and
grafting the product obtained with a silylated reagent compound.

As a variant, it is possible to polymerise the monomer (c) then esterify to the desired degree the carboxylic groups by means of polyoxyalkylated compounds and to graft the product obtained with a silylated reagent compound.

That type of reaction is known per se, for example, from patent application FR2 776 285.

The carboxylic groups present in the reaction product may then be completely or partially neutralised.

According to another aspect, the invention proposes an additive for hydraulic binders comprising the polymer described in association with a suitable solvent and, optionally, conventional additives.

The solvent preferably comprises water or is constituted by water. Using another solvent, such as an alcohol or a glycol, may be envisaged in order to improve solubilisation.

The concentration of the additive in terms of polymer depends mainly on the envisaged application. Generally, the additive comprises from 10 to 50, preferably from 20 to 40% by weight of polymer relative to the total weight.

The formulation of the additive may further comprise other conventional additives, such as anti-foaming agents, accelerants, retardants or water-repellent agents.

Furthermore, the formulation may additionally comprise formulation additives, such as, for example, anti-foaming agent stabilisers.

According to another aspect, the invention proposes a process for fluidising and retaining the workability of suspensions of mineral particles, in particular hydraulic binders, such as Portland cements, mortars, concretes and anhydrous or semi-hydrated calcium sulphates, comprising the step of adding to the suspension a suitable quantity of an additive, as described above, optionally after a step involving hydrolysis in a basic medium.

The hydraulic binder may include in particular concretes, in particular prefabricated concretes and ready-to-use concretes. Those concretes may be intended in particular for construction and civil engineering.

The quantity of additive to be added to the suspension of mineral particles naturally depends on the properties sought and the envisaged application.

However, it depends only to a small extent on the chemical nature of the mineral particles, such as cements, and thereby reveals the poor sensitivity with respect to the chemical nature of the cements used.

Generally, for a cement composition, a measure of additive of from 0.01 to 2%, preferably from 0.5 to 1% by weight of polymer relative to the weight of the cement, is suitable for most standard applications.

By way of indication, an effective measure of additive for preparing a concrete composition which is ready to use is from 0.7 to 1.5% of a formulation having 20% by weight of dry extract relative to the weight of cement.

The action mechanism of the polymers described is not completely understood, given that the mechanism of superplasticisers in cements has still not been completely elucidated in a general manner.

However, it is supposed that the fluidising effect of the superplasticisers mainly results in repulsion forces which act between the co-polymers which are adsorbed on the surface of the grains.

It is further supposed that the sensitivity of the superplasticisers is linked to the quantity of ettringite (hydrate of alumino-calcic sulphate) owing to their preferential adsorption thereon. Ettringite is formed during hydration of the C₃A (tricalcic aluminate) phase in the presence of soluble sulphates. In this manner, the quantity of ettringite would depend on the content of cements in those components, which varies greatly between different cements.

The silylated polymers according to the invention comprise Si—OR groups which are hydrolysed in an aqueous medium at a basic pH in silanol groups. Silanol groups have a great chemical affinity for silica hydrates (CSH) formed by hydration of the calcium silicates (C₂S and C₃S).

Since the content of cements in tricalcic silicates (C₃S) is higher, its relative variation is consequently lower compared with that of the content of tricalcic aluminates (typically from 55 to 65% of C₃S as compared with from 2 to 10% of C₃A).

The better retention of fluidity and extended workability observed with the polymers according to the invention could be due to a reinforcement of the effect of the silica hydrates, limiting the diffusion of water and thereby delaying setting owing to the adsorbed superplasticisers.

The action mechanism of the polymer as described makes it advantageous even outside the field of hydraulic setting compositions, such as cements, mortars, concretes and plasters. The polymer described may be advantageous as a dispersant of mineral charges in a number of other compositions, in particular in the context of paints, papers and plastics materials.

According to a final aspect, the invention relates to a composition of hydraulic binder comprising the additive described, optionally in the hydrolysed form.

The silyl groups are capable of being hydrolysed to form silanol groups in the basic aqueous medium of the composition of hydraulic binder.

Those compositions of hydraulic binder have, as the main advantage, workability which is extended and is in particular compatible with a wide range of applications, and particularly ready-to-use concretes and self-placing concretes.

The invention will be explained in greater detail with reference to the following examples, given by way of non-limiting example.

### EXAMPLES

In the examples below, the preparation of different polymers as defined above is described.

### Example 1

There is introduced into a 1 l reactor which is provided with mechanical agitation means, a heating system and nitrogen inerting:

| | |
|---|---|
| Tetrahydrofuran | 132.4 g |
| Methacrylic acid | 15.0 g |
| Polyethylene glycol methyl ether methacrylate 1100 | 102.15 g |
| Mercapto-acetic acid | 0.24 g |
| 2-(trimethylsilyloxy)ethyl methacrylate | 2.97 g |

A solution of an initialising agent is prepared by weighing 0.49 g of 2,2′-azobis-(2,4-dimethylvaleronitrile) (Vazo 52 from Dupont) in 10.0 g of tetrahydrofuran (THF).

The reaction medium is heated to 60° C. with agitation and with degassing being carried out under N₂. The initialising solution is added to the reaction medium and it is reacted for 5 hours 30 mins. at a temperature of 60° C. In order to stabilise the THF, a small quantity of water is added. Distillation is subsequently carried out under a vacuum in order to eliminate the solvent.

The product obtained is a viscous liquid which is diluted with water in order to obtain a solution having a concentration of approximately 30% by weight.

The molar mass of the co-polymer obtained is Mw=45240.

### Example 2

There is introduced into a 1 l reactor which is provided with mechanical agitation means, a heating system and nitrogen inerting:

| | |
|---|---|
| Tetrahydrofuran | 180.0 g |
| Methacrylic acid | 14.6 g |
| Polyethylene glycol methyl ether methacrylate 1100 | 99.6 g |
| Mercapto acetic acid | 0.28 g |
| 3-[tris(trimethylsilyloxy)silyl] propyl methacrylate | 5.9 g |

A solution of an initialising agent is prepared by weighing 0.68 g of 2,2′-azobis-(2,4-dimethylvaleronitrile) (Vazo 52 from Dupont) in 10.0 g of tetrahydrofuran (THF).

The reaction medium is heated to 60° C. with agitation and with degassing being carried out under N₂. The initialising solution is added to the reaction medium and the solution is reacted for 5 hours 30 mins. at a temperature of 60° C. In order to stabilise the THF, a small quantity of water is added. Distillation is subsequently carried out under a vacuum in order to eliminate the solvent.

The product obtained is a viscous liquid which is diluted with water in order to obtain a solution having a concentration of approximately 30% by weight.

### Example 3

There is introduced into a 1 l reactor which is provided with mechanical agitation means, a heating system and nitrogen inerting:

| | |
|---|---|
| Tetrahydrofuran | 180.0 g |
| Methacrylic acid | 12.1 g |
| Polyethylene glycol methyl ether methacrylate 1100 | 102.8 g |
| Mercapto acetic acid | 0.24 g |
| 3-[tris(trimethylsilyloxy)silyl] propyl methacrylate | 5.3 g |

A solution of an initialising agent is prepared by weighing 0.61 g of 2,2′-azobis-(2,4-dimethylvaleronitrile) (Vazo 52 from Dupont) in 10.0 g of tetrahydrofuran (THF).

The reaction medium is heated to 60° C. with agitation and with degassing being carried out under N₂. The initialising solution is added to the reaction medium and the solution is reacted for 5 hours 30 mins. at a temperature of 60° C. In order to stabilise the THF, a small quantity of water is added. Distillation is subsequently carried out under a vacuum in order to eliminate the solvent.

The product obtained is a viscous liquid which is diluted with water in order to obtain a solution having a concentration of approximately 30% by weight.

### Example 4

There is introduced into a 1 l reactor which is provided with mechanical agitation means, a heating system and nitrogen inerting:

| | |
|---|---|
| Tetrahydrofuran | 180.0 g |
| Methacrylic acid | 10.7 g |
| Polyethylene glycol methyl ether methacrylate 1100 | 99.4 g |
| Mercapto acetic acid | 0.22 g |
| 3-[tris(trimethylsilyloxy)silyl] propyl methacrylate | 10.2 g |

A solution of an initialising agent is prepared by weighing 0.59 g of 2,2′-azobis-(2,4-dimethylvaleronitrile) (Vazo 52 from Dupont) in 10.0 g of tetrahydrofuran (THF).

The reaction medium is heated to 60° C. with agitation and with degassing being carried out under N₂. The initialising solution is added to the reaction medium and the solution is reacted for 5 hours 30 mins. at a temperature of 60° C. In order to stabilise the THF, a small quantity of water is added. Distillation is subsequently carried out under a vacuum in order to eliminate the solvent.

The product obtained is a viscous liquid which is diluted with water in order to obtain a solution having a concentration of approximately 30% by weight.

### Example 5

There is introduced into a 1 l reactor which is provided with mechanical agitation means, a heating system and nitrogen inerting:

| | |
|---|---|
| Tetrahydrofuran | 180.0 g |
| Methacrylic acid | 8.6 g |
| Polyethylene glycol methyl ether methacrylate 1100 | 99.8 g |
| Acrylamide | 1.8 g |
| Mercapto acetic acid | 0.24 g |
| 3-[tris(trimethylsilyloxy)silyl] propyl methacrylate | 10.2 g |

A solution of an initialising agent is prepared by weighing 0.59 g of 2,2′-azobis-(2,4-dimethylvaleronitrile) (Vazo 52 from Dupont) in 10.0 g of tetrahydrofuran (THF).

The reaction medium is heated to 60° C. with agitation and with degassing being carried out under N₂. The initialising solution is added to the reaction medium and the solution is reacted for 5 hours 30 mins. at a temperature of 60° C. In order to stabilise the THF, a small quantity of water is added. Distillation is subsequently carried out under a vacuum in order to eliminate the solvent.

The product obtained is a viscous liquid which is diluted with water in order to obtain a solution having a concentration of approximately 30% by weight.

### Example 6

There is introduced into a 1 l reactor which is provided with mechanical agitation means, a heating system and nitrogen inerting:

| | |
|---|---|
| Methacrylic acid | 10.9 g |
| Polyethylene glycol methyl ether methacrylate 1100 | 99.3 g |
| Mercapto acetic acid | 0.23 g |
| 3-[tris(trimethylsilyloxy)silyl] propyl methacrylate | 10.2 g |

The reaction medium is heated to 60° C. with agitation and with degassing being carried out under N₂. 0.59 g of 2,2′-azobis-(2,4-dimethylvaleronitrile) (Vazo 52 from Dupont) are added to the reaction medium as an initialising agent and the solution is reacted for 5 hours 30 mins. at a temperature of 60° C.

The product obtained is a viscous liquid which is diluted with water in order to obtain a solution having a concentration of approximately 30% by weight.

### Example 7

There is introduced into a 1 l reactor which is provided with mechanical agitation means, a heating system and nitrogen inerting:

| | |
|---|---|
| Tetrahydrofuran | 190.0 g |
| Methacrylic acid | 11.0 g |
| Polyethylene glycol methyl ether methacrylate 1100 | 102.9 g |
| Mercapto acetic acid | 0.23 g |
| 3-[tris(trimethoxysilyl)] propyl methacrylate | 6.2 g |

A solution of an initialising agent is prepared by weighing 0.61 g of 2,2′-azobis-(2,4-dimethylvaleronitrile) (Vazo 52 from Dupont) in 10.0 g of tetrahydrofuran (THF).

The reaction medium is heated to 60° C. with agitation and with degassing being carried out under N₂. The initialising solution is added to the reaction medium and the solution is reacted for 5 hours 30 mins. at a temperature of 60° C. In order to stabilise the THF, a small quantity of water is added. Distillation is subsequently carried out under a vacuum in order to eliminate the solvent.

The product obtained is a viscous liquid which is diluted with water in order to obtain a solution having a concentration of approximately 30% by weight.

### Example 8

There is introduced into a 1 l reactor which is provided with mechanical agitation means, a heating system and nitrogen inerting:

| | |
|---|---|
| Tetrahydrofuran | 180.0 g |
| Methacrylic acid | 12.3 g |
| Polyethylene glycol methyl ether methacrylate 1100 | 104.6 g |
| Mercapto acetic acid | 0.24 g |
| 3-(trimethoxysilyl)propyl methacrylate | 3.2 g |

A solution of an initialising agent is prepared by weighing 0.62 g of 2,2′-azobis-(2,4-dimethylvaleronitrile) (Vazo 52 from Dupont) in 10.0 g of tetrahydrofuran (THF).

The reaction medium is heated to 60° C. with agitation and with degassing being carried out under N₂. The initialising solution is added to the reaction medium and the solution is reacted for 5 hours 30 mins. at a temperature of 60° C. In order to stabilise the THF, a small quantity of water is added. Distillation is subsequently carried out under a vacuum in order to eliminate the solvent.

The product obtained is a viscous liquid which is diluted with water in order to obtain a solution having a concentration of approximately 30% by weight.

### Example 9

### (For Comparison)

There is introduced into a 1 l reactor which is provided with mechanical agitation means, a heating system and nitrogen inerting:

| | |
|---|---|
| Tetrahydrofuran | 180.0 g |
| Methacrylic acid | 13.6 g |
| Polyethylene glycol methyl ether methacrylate 1100 | 106.4 g |
| Mercapto acetic acid | 0.24 g |

A solution of an initialising agent is prepared by weighing 0.63 g of 2,2′-azobis-(2,4-dimethylvaleronitrile) (Vazo 52 from Dupont) in 10.0 g of tetrahydrofuran (THF).

The reaction medium is heated to 60° C. with agitation and with degassing being carried out under N₂. The catalyst solution is added to the reaction medium and the solution is reacted for 5 hours 30 mins. at a temperature of 60° C. In order to stabilise the THF, a small quantity of water is added. Distillation is subsequently carried out under a vacuum in order to eliminate the solvent.

The product obtained is a viscous liquid which is diluted with water in order to obtain a solution having a concentration of approximately 30% by weight.

### Example 10

There is introduced into a 1 l reactor which is provided with mechanical agitation means, a heating system and a distillation column:

| | |
|---|---|
| Methacrylic polyacid at ES = 30% | 250 g |
| Methoxy polyethylene glycol 750 | 128 g |
| Methoxy polyethylene glycol 2000 | 341 g |
| Sodium carbonate at 50% | 1.75 g |

Heating is carried out to 170° C. after distillation of the water contained in the raw materials under high vacuum of 10 mmHg until all the ethylene polyoxide has reacted (that is, 7 hours) . Cooling is then carried out to 80° C. and there is added:
(3-aminopropyl)triethoxysilane 21.3 g

Addition is carried out slowly for 3 minutes and it is allowed to react for 30 minutes at 80° C. The product becomes quite viscous but remains soluble. Dilution with water is then carried out in order to have a product of 20% of dry extract.

a. Characterising the Co-Polymers Prepared

The molar mass of the co-polymers prepared is established by gel permeation chromatography (GPC) using the aqueous method under the following conditions:
flow rate 1 ml/min.;
temperature of the columns 35° C.
columns of the type Aquagel OH 30 (Polymer Laboratories) and SHODEX MHQ 860 (ALTECH).

Internal standard calibration PEG Mp 260 at 300,000.

The molar masses of the co-polymers prepared in accordance with Examples 1 to 9 were established by GPC as indicated above and are set out in Table 1 below.

TABLE 1
Molar mass and polymerisation index of the co-
polymers prepared

| EXAMPLE No. | Mw | Ip |
|---|---|---|
| 1 | 45240 | 2.1 |
| 2 | 37900 | 1.9 |
| 3 | 38300 | 2.0 |
| 4 | 54223 | 2.9 |
| 5 | 62896 | 3.6 |
| 6 | 108465 | 4.6 |
| 7 | 52423 | 2.8 |
| 8 | 77440 | 3.7 |
| 9 | 46497 | 2.6 |
| 10 | 30834 | 1.92 |

b. Measuring the Spread

The spread of the cement compositions is established in accordance with the following protocol at constant temperature.

A frustoconical mould which has no base and which is a reproduction on a scale of 0.5 of the Abrams cone is used and is characterised by the following dimensions:

| | |
|---|---|
| diameter of the upper base circle | 50 mm, |
| diameter of the lower base circle | 100 mm and |
| height | 150 mm. |

This cone is filled with the sample in the fresh state in three layers of identical volume, then the sample is pierced between each layer using a steel rod having a diameter of 6 mm, a length of 300 mm and a spherical end. Subsequently, the upper surface of the cone is shaved, then it is removed from the mould onto a clean surface and the cone is raised vertically. The settlement is measured at the highest point and the spread is measured according to four diameters at 45° C. with a sliding calliper. The spread is given by the mean of the four measurements.

c. Metering Tests

The additives obtained, in the form of co-polymers prepared in an aqueous solution at approx. 30% by weight, were tested in terms of the useful measure. To that end, the quantity of additive necessary to obtain a spread of approximately 320±10 mm for a mortar prepared in the following manner was established:

1350.4 g of standardised ISO sand is introduced in the bowl of a mixer (Perrier BA 008). Then 6% by mass, in terms of the sand, of wetting water was added with mixing at a rate of approximately 140 rpm within 30 seconds. Mixing was continued for 30 seconds before the admixture was allowed to rest for 4 minutes. Subsequently, 624.9 g of the specified cement and 412.1 g of calciferous filler were added (BL 200, OMYA), then mixed for 1 minute before adding the mixing water and the specified measure of additive, whilst still mixing. After those steps, mixing was continued for a further 2 minutes at 280 rpm.

The tests were carried out for the additives prepared in examples 1 to 9 and a reference product of the polycarboxylate type (Glenium 27 from Master Builder Technologies), which, similarly to the additive according to example 9, does not comprise any silanol group.

TABLE 2
Metering [% by dry weight of additive/weight of cement]

| | Example No. | | | | | | | |
|---|---|---|---|---|---|---|---|---|
| | Ref. | 1 | 2 | 3 | 4 | 5 | 8 | 9 |
| A | 0.26 | 0.25 | 0.23 | 0.22 | 0.22 | 0.28 | 0.23 | 0.23 |
| C | 0.43 | 0.35 | 0.30 | 0.35 | 0.26 | 0.35 | 0.25 | 0.41 |

It is evident that the metering deviation between the cements is distinctly higher for the reference product than for the additives based on a polymer carrying a silyl group in the Examples 1 to 8.

It will further be appreciated that the additive according to Example 9, which is prepared similarly to the other polymers but without any silylated compound, has a deviation comparable to the commercially available product and, in any case, far greater than that of the co-polymers having a silanol group.

Thus, it appears from these results that the presence in the polymer of a group capable of hydrolysing to form a silanol group reduces the variation in metering between different cements and thereby allows an improvement in the robustness of the additive.

Another series of tests was carried out on mortars comprising, as a granulate, standardised sand and four cements A, B, C and D having a different content in terms of soluble alkalines.

The mortars were prepared in accordance with the protocol described above.

The measure of additive for each of the four cements, established in accordance with Standard N196 and expressed as a percentage relative to the weight of cement of the mortar, is indicated in Table 3 below:

TABLE 3
Metering [% by dry weight of additive/weight of cement]

| | Soluble Na₂O | | | | | |
|---|---|---|---|---|---|---|
| Cement | eq. | Ref. | 7 | 8 | 9 | 10 |
| A CM1 525 | 0.24 | 0.11 | 0.12 | 0.10 | 0.10 | 0.10 |
| B | 0.60 | 0.50 | 0.21 | 0.19 | 0.30 | 0.23 |
| C | 0.46 | 0.33 | 0.17 | 0.17 | 0.20 | 0.17 |
| D | 0.34 | 0.25 | 0.17 | 0.15 | 0.18 | 0.15 |

The measure for cement A having a very low content of soluble alkalines is, in all the cases studied, lower than for cement B having a very high content of soluble alkalines; however, it will readily be observed that this difference becomes less clear for the additives of examples 7, 8 and 10 based on a polymer carrying a silyl group compared with the reference additives or additives of example 9 which do not comprise this type of group.

c. Workability Retention Tests

The additives prepared were characterised in terms of retaining workability by means of the following tests.

The evolution of the spread of the mortars prepared in accordance with the procedure above was evaluated as indicated above at 5, 15, 30, 60 and 90 minutes of preparation. The results are set out in Tables 4a to 4e below.

TABLE 4a
Workability retention of the reference product

| REF | Spread [mm] | | | | |
|---|---|---|---|---|---|
| Cement | 5 | 15 | 30 | 60 | 90 |
| A | 310 | 295 | 285 | 266 | 225 |
| B | 330 | 332 | 339 | 345 | 335 |
| C | 335 | 350 | 360 | 360 | 360 |
| D | 320 | 340 | 340 | 335 | 325 |

TABLE 4b
Workability retention of the additive of Example 7

| EXAMPLE 7 | Spread [mm] | | | | |
|---|---|---|---|---|---|
| Cement | 5 | 15 | 30 | 60 | 90 |
| A | 335 | 335 | 315 | 280 | 245 |
| B | 306 | 365 | 373 | 375 | 362 |
| C | 315 | 370 | 372 | 356 | 335 |
| D | 300 | 355 | 345 | 305 | 270 |

TABLE 4c
Workability retention of the additive of Example 8

| EXAMPLE 8 | Spread [mm] | | | | |
|---|---|---|---|---|---|
| Cement | 5 | 15 | 30 | 60 | 90 |
| A | 320 | 310 | 295 | 265 | 220 |
| B | 335 | 370 | 370 | 370 | 360 |
| C | 335 | 378 | 380 | 360 | 352 |
| D | 310 | 350 | 330 | 300 | 270 |

TABLE 4d
Workability retention of the additive of Example 9

| EXAMPLE 9 | Spread [mm] | | | | |
|---|---|---|---|---|---|
| Cement | 5 | 15 | 30 | 60 | 90 |
| A | 325 | 310 | 290 | 270 | 235 |
| B | 330 | 325 | 320 | 330 | 310 |
| C | 330 | 330 | 330 | 322 | 310 |
| D | 330 | 340 | 330 | 315 | 300 |

TABLE 4e
Workability retention of the additive of Example 10

| EXAMPLE 10 | Spread [mm] | | | | |
|---|---|---|---|---|---|
| Cement | 5 | 15 | 30 | 60 | 90 |
| A | 340 | 330 | 315 | 285 | 240 |
| B | 270 | 310 | 300 | 305 | 285 |
| C | 320 | 250 | 350 | 350 | 350 |
| D | 280 | 325 | 325 | 325 | 295 |

The workability retention is substantially equal to Glenium 27 but with a lower measure which is 0.11-0.50-0.33-0.25 for Glenium 27, respectively.

Therefore, there is observed for all the cements tested a fluidity retention over time that is comparable to the reference product, in spite of the strong reduction in the measure of additive.

1-16. (canceled)

17. Additive for hydraulic binders comprising a polymer comprising a hydrocarbon chain, lateral silyl groups and polyoxyalkylated groups, wherein the polyoxyalkylated groups are linked to the main chain by an ester, ether or amide bond and a suitable solvent.

18. Additive according to claim 17, wherein the polymer further comprises lateral carboxylic groups.

19. Additive according to claim 17, wherein the polymer comprises from 0.001 to 50% in number of silyl groups.

20. Additive according to claim 17, wherein the polymer comprises lateral silyl groups having the formula —Si(R)ₓ(OR)_{y}, where R are alkyl groups, preferably of C1 to C6, x is an integer from 0 to 2 and y is an integer from 1 to 3, the sum of x and y being 3.

21. Additive according to claim 17 the polymer comprises lateral silyl groups, in which the central silicon atom carries itself one or more silyl groups having the formula —Si(R)x(OR)y, where R are alkyl groups, preferably of C1 to C6, x is an integer from 0 to 2 and y is an integer from 1 to 3, the sum of x and y being 3.

22. Additive according to claim 18, wherein the polymer comprises from 1 to 80% in number of carboxylic groups.

23. Additive according to claim 17, wherein the polymer comprises from 0 to 80% in number of polyoxyalkylated groups.

24. Additive according to claim 17, wherein the polymer has a mean molar mass of between 10,000 and 220,000 (Mw).

25. Additive according to claim 18, wherein the carboxylic groups of the polymer are at least partially neutralized.

26. Additive according to claim 17, wherein the solvent is water.

27. Additive according to claim 17, comprising from 10 to 50, preferably from 20 to 40% by weight of polymer relative to the total weight.

28. Process for fluidizing and retaining the workability of suspensions of mineral particles, in particular compositions of cements, such as Portland cements, mortars, concretes and anhydrous or semi-hydrated calcium sulphates, comprising the step of adding to the suspension a suitable quantity of an additive according to claim 17, optionally after a step involving hydrolysis in a basic medium.

29. Composition of a hydraulic binder comprising the additive according to claim 17.

30. Composition according to claim 29, wherein the hydraulic binder is a concrete composition.

31. Composition according to claim 30, wherein the hydraulic binder is a ready-to-use concrete or self-placing concrete.
